(19) United States
(12) Patent Application Publication
(10) Pub. No.: US 2023/0012518 A1
(43) Pub. Date: Jan. 19, 2023

(54) Pressure Sensing Device

(71) Applicant: Peratech Holdco Limited, North Yorkshire (GB)

(72) Inventors: XU FENG, Jiansu (CN); Sun Kun, Jiansu (CN); Li Zefeng, Jiansu (CN)

(21) Appl. No.: 17/784,699

(22) PCT Filed: Dec. 11, 2020
(86) PCT No.: PCT/GB2020/000098

§ 371 Date: Jun. 13, 2022

(30) Foreign Application Priority Data
Dec. 13, 2019 (CN) ZL 201922244791.3

(51) Int. Cl. G01L 5/00; G01L 9/00

(52) U.S. Cl. CPC G01L 5/0038; G01L 9/0051

(57) ABSTRACT

A pressure sensing device comprises a first diaphragm which is deformable and a second diaphragm which is non-deformable. One of the diaphragms comprises a pressure sensitive material arranged on its surface. The other diaphragm comprises a detection electrode arranged its surface. The first diaphragm forms part of a force transmission device comprising a cavity having a force transmission fluid therein. The force transmission device is configured to receive an external force and transmit the external force to the first diaphragm, such that the first and second diaphragms are mutually deformed in response to the external force.

### CROSS REFERENCE TO RELATED APPLICATIONS

This application claims priority from Chinese Utility Model number ZL 2019 2 2244791.3, filed on 13 Dec. 2019, the whole contents of which are incorporated herein by reference.

### BACKGROUND OF THE INVENTION

The present invention relates to a pressure sensing device comprising a deformable diaphragm and a non-deformable diaphragm.

Pressure sensing devices such as pressure sensors and transducers are known in the art to, in response to an applied pressure, convert the pressure to an appropriate output by means of electrical signals generated from the pressure sensor or transducer.

Conventional thin film pressure sensors often comprise two conductive layers which sandwich a pressure sensitive layer and which are brought together under the application of an applied pressure or force to allow for a measurement of force to be translated into a suitable output.

Conventional pressure sensing devices of this type often have issues in regards to the consistency and accuracy of the measurements and their subsequent output. For example, a given pressure applied at a given point on the surface of the pressure sensing device can produce a different output to the same pressure applied at a different point on the surface of the pressure sensor.

### BRIEF SUMMARY OF THE INVENTION

According to a first aspect of the present invention, there is provided a pressure sensing device, comprising: a first diaphragm which is deformable; and a second diaphragm which is non-deformable; one of said first or second diaphragms comprises a pressure sensitive material arranged on a surface of said one of said first or second diaphragms; and the other of said first or second diaphragms comprises a detection electrode arranged on a surface of said other said first or second diaphragms; wherein said first diaphragm forms part of a force transmission device comprising a cavity having a force transmission fluid therein; said force transmission device is configured to receive an external force and transmit said external force to said first diaphragm, such that said first and second diaphragms are mutually deformed in response to said external force.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows a first embodiment of a pressure sensing device of the present invention;

FIG. 2 shows a schematic diagram of the pressure sensing device of FIG. 1 under an application of pressure;

FIG. 3 shows a schematic diagram of the structure of the detection electrode of a pressure sensing device in accordance with the present invention;

FIG. 4 shows a cross-sectional view of a second embodiment of a pressure sensing device of the present invention;

FIG. 5 shows a schematic diagram of the pressure sensing device of FIG. 4 under an application of pressure;

FIG. 6 shows a schematic diagram of the pressure sensing device of FIG. 4 under an alternative applied pressure;

FIG. 7 shows a schematic diagram of the pressure sensing device of FIG. 4 when a pressure is applied on both sides of the pressure sensing device;

FIG. 8 shows a cross-sectional view of a third embodiment of a pressure sensing device of the present invention;

FIG. 9 shows a schematic diagram the pressure sensing device of FIG. 8 under an application of pressure;

FIG. 10 shows a cross-sectional view of a fourth embodiment of pressure sensing device of the present invention;

FIG. 11 shows a schematic diagram of the pressure sensing device of FIG. 10 under an application of pressure.

### DETAILED DESCRIPTION OF EMBODIMENTS OF THE INVENTION

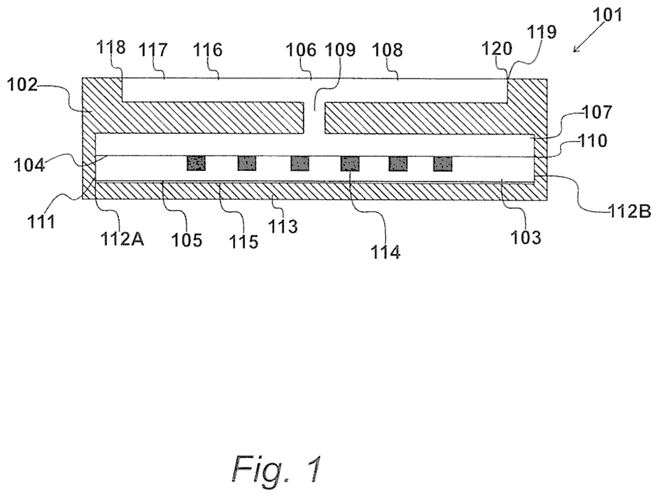

### FIG. 1

A pressure sensing device in accordance with a first embodiment of the present invention is illustrated in cross-sectional form in FIG. 1. Pressure sensing device 101 may be considered a thin-film pressure sensor. However, it is appreciated that other pressure sensing devices which operate in a substantially similar manner to the claimed invention are within the scope of protection sought.

Pressure sensing device 101 comprises a housing 102 which includes a force transmission device 103 defined by housing 102. Pressure sensing device 101 further comprises a first diaphragm 104 and a second diaphragm 105.

Housing 102 is provided with a cavity 106 which comprises an inner cavity 107, an outer cavity 108 and a channel 109. Channel 109 connects inner cavity 107 to outer cavity 108 and is located substantially centrally along a central longitudinal axis of pressure sensing device 101. Channel 109 has a central axis therethrough which is perpendicular to the longitudinal axis of pressure sensing device 101.

Housing 102 comprises a rigid insulating material. In an embodiment, the rigid insulating material comprises a plastics material. In an alternative embodiment, the rigid insulating material comprises glass. It is appreciated that any other suitable rigid insulating material may be utilized in this capacity.

In the embodiment, diaphragm 104 is deformable, while diaphragm 105 is a non-deformable. In the embodiment, deformable diaphragm 104 is arranged in inner cavity 107. In the embodiment, diaphragm is suspended between a first edge 110 and a second edge 111 such that, at each edge 110 and 111 diaphragm 104 is hermetically sealed to a lower side wall 112 of inner cavity 107. By being deformable, diaphragm 104 is therefore able to undergo a change in shape when subjected to an external force. Given the means of attachment to the side wall, in this embodiment diaphragm 104 deforms in a direction normal to the longitudinal plane of pressure sensing device 101.

Diaphragm 105 is attached to a lower wall 113 of inner cavity 107. Lower wall 113 forms part of housing 102 and consequently comprises a rigid insulating material. Thus, in this embodiment, lower wall 113 is substantially rigid.

In the embodiment, the lower surface of diaphragm 104 is provided with a detection electrode 114. Diaphragm 105 is provided with a corresponding pressure sensitive material 115 coated on its upper surface.

In the embodiment, pressure sensitive material 115 comprises a quantum tunnelling material which is available from the present applicant Peratech Holdco Limited, Brompton-on-Swale, United Kingdom sold under the trade mark QTC®. This is a material which, with increased application of force exhibits a change in resistance. It is appreciated that, in other embodiments, detection electrode 114 and pressure sensitive material 115 can be arranged in reverse.

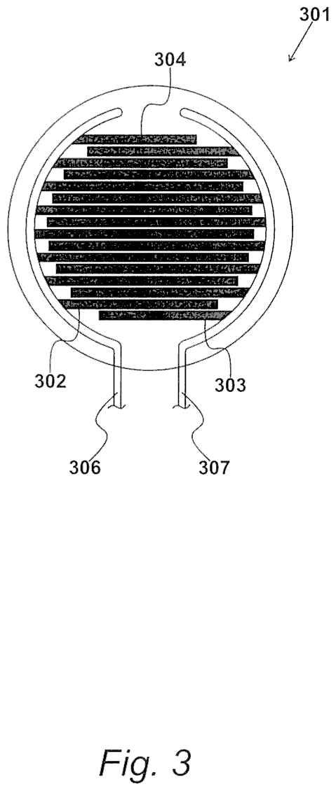

The pressure sensitive material is configured to exhibit a change in resistance in response to an applied pressure, and, in combination with a conductive material of the detection electrode (which will be described further with respect to FIG. 3) the magnitude of an applied pressure can be calculated based on the output resistance.

Generally, the greater the pressure between the two diaphragms and the larger the contact area of the force applied, the smaller the measured resistance value, and vice versa.

In the embodiment, cavity 106 comprises a force transmission fluid therein. Force transmission fluid can be any non-conductive liquid such as silicone oil, glycerin, or any other suitable liquid.

In the embodiment, an elastic membrane 116 is provided at an opening 117 of cavity 106 of housing 102. Elastic membrane 116 is sealed at its edges 118 and 119 to the inner wall 120. Elastic membrane 116 comprises an elastic and wear-resistant membrane, such as a silicon membrane.

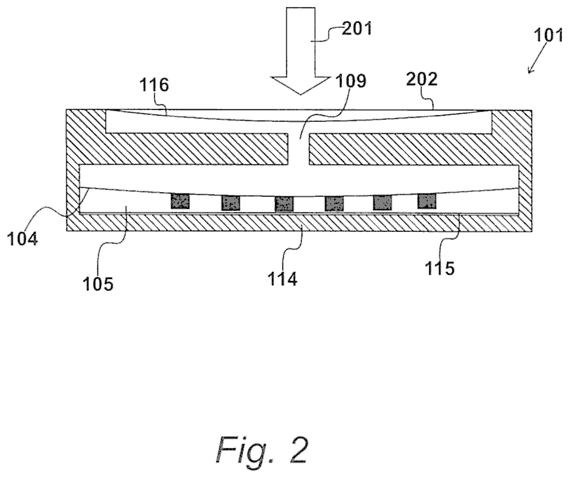

### FIG. 2

Pressure sensing device 101 is shown in FIG. 2 in the form of a schematic diagram following the application of a pressure.

In the embodiment, a force 201 is applied on an upper surface 202 of elastic membrane 116. This application of force may be from a user's finger, in for example, in an embodiment where the pressure sensing device is incorporated into an electronic device which requires pressure inputs from a user.

In the embodiment, force 201 is absorbed by the force transmission fluid and transmitted to diaphragm 104. Diaphragm 104 then moves in response to force 201 and deformation of diaphragm 104 occurs about the center of diaphragm 104 due to the positioning of channel 109.

In this way, diaphragm 104 moves to be in closer proximity to diaphragm 105. Thus, as the pressure sensitive material 115 and the detection electrode 114 are arranged between diaphragm 104 and diaphragm 105, the difference in the distance between the two diaphragms is changed. This leads to a change in pressure and consequently resistance and the contact area can be consequently measured corresponding to the change in electrical signal.

The pressure sensing device of this embodiment absorbs and conducts external pressure through the force transmission fluid and utilizes the fluid to have the isotropic property of force transmission, irrespective of a user applying a force at a different position on the elastic membrane. Thus, this achieves uniform conduction through the force transmission fluid thereby ensuring the accuracy and consistency of the measurement.

Specifically, when force 201 is applied on upper surface 202, force 201 acts on elastic membrane 116 which causes the force transmission fluid to flow from the outer cavity 108 to the inner cavity 107. Diaphragm 201 is pushed downwards by the force transmission fluid and deforms, which in turn allows the detection electrode 114 to contact with the pressure sensitive material 115 of diaphragm 105. During this process, the resistance value measured from the pressure sensitive material changes gradually, and the change in resistance value can be measured accordingly.

It is noted that diaphragm 104 has an elastic strength which is sufficient to support the weight of the force transmission fluid, such that the diaphragm does not deform significantly without the application of an external force.

### FIG. 3

Referring to FIG. 3, an example detection electrode 301 is shown plan view in isolation. Detection electrode 301 may be substantially similar to detection electrode 114 of FIG. 1 and comprises a first plurality of conductive fingers 302 and a second plurality of conductive fingers 303. In the embodiment, the first plurality of conductive fingers 302 and second plurality of conductive fingers 303 are arranged at alternative intervals to each other to produce an arrangement of interdigitated fingers 304.

In the embodiment, the first plurality of conductive fingers 302 are connected to an electrode 306 while the second plurality of conductive fingers 303 is connected to an electrode 307. In the embodiment, electrode 306 is positive and electrode 307 is negative.

The arrangement of the interdigitated fingers 304 and the electrodes 306 and 307 provide a detection area 308 which, in the embodiment is substantially circular. In an alternative embodiment, it is appreciated that detection area 308 may take any suitable geometric shape and, in one embodiment, detection area 308 is substantially rectangular.

In the embodiment, each plurality of conductive fingers comprises a carbon-based material, such as a carbon-based ink.

Detection electrode 301 is used in combination with pressure sensitive material 115 in a substantially similar manner as described in FIGS. 1 and 2 to enable a force to be calculated in response to an applied pressure. Consequently, detection electrode 301 can be connected to an electrical circuit by means of electrodes 306 and 307 to provide an output of electrical resistance.

In combination with the pressure sensitive material 115, when a force is applied, such as force 201 in FIG. 2, when pressure sensitive material 115 contacts both first plurality of conductive fingers 302 and second plurality of conductive fingers 303 at the same time, a detection loop is formed and the corresponding resistance value can be calculated.

As diaphragm 104 and diaphragm 105 contact each other, pressure sensitive material 115 and each of the conductive fingers contact each other allowing for readings of resistance and pressure to be made as described.

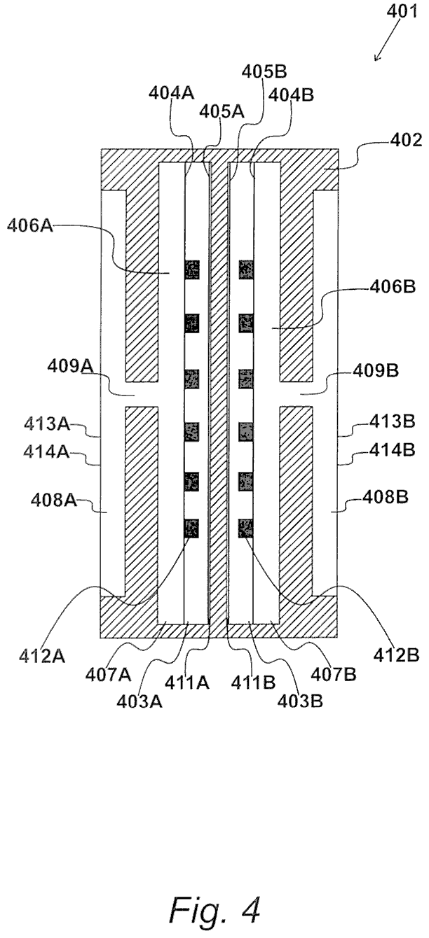

### FIG. 4

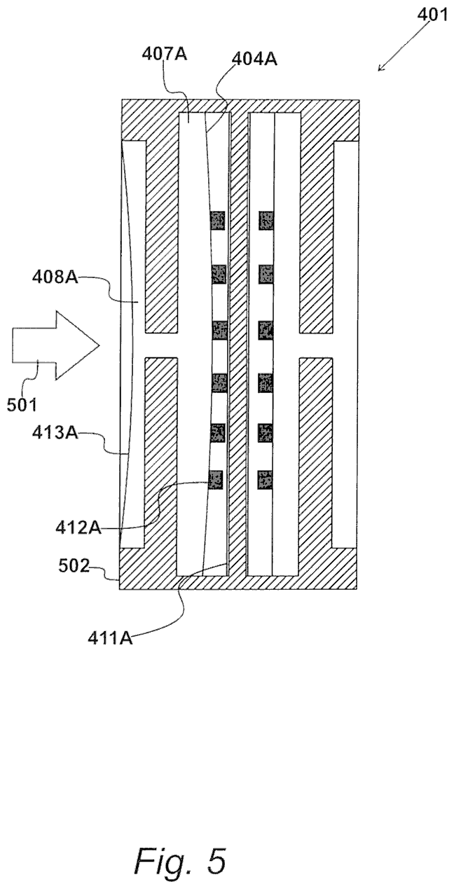

A cross-sectional view of a second embodiment of a pressure sensing device 401 in accordance with the present invention will now be described with respect to FIGS. 4 and 5.

In this second embodiment, pressure sensing device 401 may again be considered a thin-film pressure sensor. However, it is appreciated that other pressure sensing devices which operate in a substantially similar manner to the claimed invention are within the scope of protection sought.

Pressure sensing device 401 comprises a housing 402 which includes a first force transmission device 403A defined by housing 402 and a second force transmission device 403B. Pressure sensing device 401 further comprises a first diaphragm 404A, a second diaphragm 405A, third diaphragm 404B and fourth diaphragm 405B.

In the embodiment, each force transmission device 403 is provided with a cavity 406 which comprises an inner cavity 407, an outer cavity 408 and a channel 409. In a similar manner to the embodiment of FIGS. 1 and 2, channel 409 connects inner cavity 407 to outer cavity 408 and is located substantially centrally along a central longitudinal axis of pressure sensing device 401. Each channel 409 has a central axis therethrough which is perpendicular to the longitudinal axis of pressure sensing device 401.

The arrangement of each force transmission device is symmetrical along the longitudinal axis of the pressure sensing device 401, with each force transmission device 403 being substantially similar to force transmission device 103.

As shown in FIG. 4, inner cavities 406A and 406B share a center wall 410, which comprises a wall of substantially rigid material and is non-deformable. The rigid material may comprise a plastics material or an alternative material such as glass.

In the embodiment, diaphragms 405A and 405B are non-deformable and attached to opposite sides of wall 410. Diaphragms 405A and 405B are each provided with a pressure sensitive material 411 coated on their upper surface. As described previously, pressure sensitive material 411 comprises a quantum tunnelling material.

Diaphragms 404A and 404B are deformable and arranged in their respective inner cavities 407A and 407B. In a similar manner to pressure sensing device 101, each diaphragm 404 is suspended at its edges and hermetically sealed to the side wall of the cavity. Diaphragms 404A and 404B are each further provided with a detection electrode 412 on the surface closest to wall 410. Detection electrode 412 is substantially similar to detection electrode 301 described previously with respect to FIG. 3. It is appreciated, however, that alternative detection electrodes may be utilized in the invention.

In the embodiment, each cavity 406 comprises a force transmission fluid therein and an elastic membrane 413 is provided at an opening 414. Again, each elastic membrane 413A, 413B is sealed at its edges to the inner wall of housing 402.

In this embodiment, the two force transmission devices are arranged back-to-back, however, the arrangement ensures that the force transmission devices work independently of each other. In this way, any measurements recorded following the application of a force can be superimposed to increase the total measurement value.

### FIG. 5

A schematic diagram of pressure sensing device 401 is shown in FIG. 5 under an application of pressure 501. In this embodiment, pressure 501 is applied to a first side 502 of pressure sensing device 401.

On application of pressure 501, pressure 501 acts on elastic membrane 413A which deforms in the direction in which the pressure is applied. The force transmission fluid in cavity 406A therefore flows from outer cavity 408A to inner cavity 407A, thereby moving and deforming diaphragm 404A, again in the direction of applied pressure 501.

The movement of diaphragm 404A brings detection electrode 412A into contact with pressure sensitive material 411A. Thus, in a substantially similar manner to that described previously, a change in resistance value can be measured.

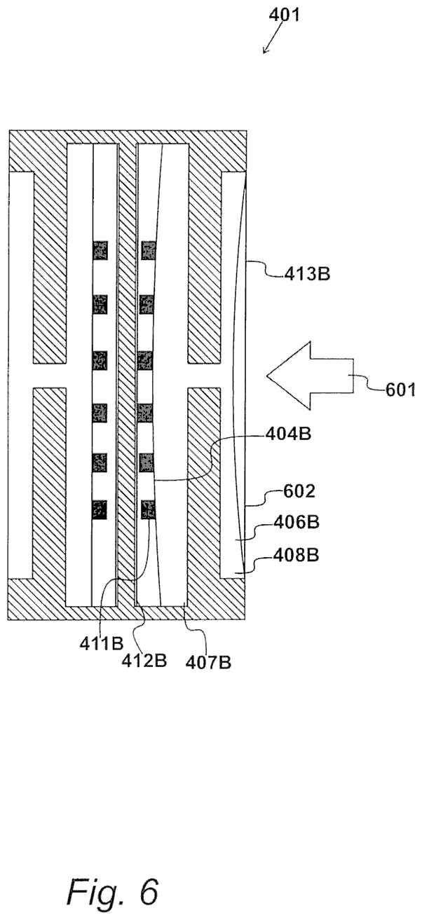

### FIG. 6

A further schematic diagram of pressure sensing device 401 is shown in FIG. 6 under an application of pressure 601. In this embodiment, pressure 601 is applied to a second side 602 of pressure sensing device 401.

On application of pressure 601, pressure 601 acts on elastic membrane 413B which deforms in the direction in which the pressure is applied. The force transmission fluid in cavity 406B therefore flows from outer cavity 408B to inner cavity 407B, thereby moving and deforming diaphragm 404B, again in the direction of applied pressure 601.

In a similar manner to the embodiment of FIG. 5, the movement of diaphragm 404B brings detection electrode 412B into contact with pressure sensitive material 411B. Thus, a change in resistance value can be measured.

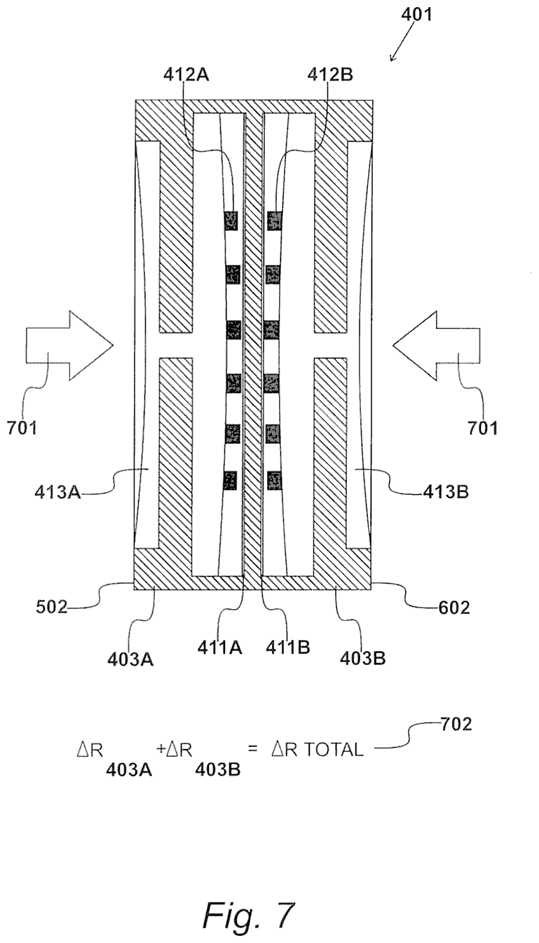

### FIG. 7

A still further schematic diagram of pressure sensing device 401 is shown in FIG. 7 under an application of pressure 701. In this embodiment, pressure 701 is applied to both first and second sides 502 and 602 of pressure sensing device 401.

On application of pressure 701 from both sides of force sensing device 401, pressure 701 acts on each elastic membrane 413 which deform in a substantially similar manner to their deformations in FIGS. 5 and 6. This in turn allows the force transmission fluid in each cavity to move and deform diaphragms 404 leading to contact between detection electrodes 412 and pressure sensitive material 411 at each side.

Again, the change in resistance can be measured for each force transmission device 403. As depicted by equation 702, if the change in resistance measured in force transmission device 403A is ΔR_{403A} and the change in resistance measured in force transmission device 403B is ΔR_{403B}, then force sensing device 401 measure a total resistance change of ΔR_{403A}+ΔR_{403B}. For a given applied pressure therefore, pressure sensing device 401 obtains twice the measured value which enables the detection sensitivity to be improved, particularly in the case of low applied pressures.

In the embodiment, channel 409A and 409B are positioned along the same axis along the center of force sensing device 401.

When a pressure 701 is applied to force sensing device 401, the point at which the pressure is applied can be any point along elastic membrane 413A or 413B or both. However, due to force transmission fluid, the pressure value received at any point on either of the deformable diaphragms 404 is equal, and is equal to the applied pressure 701.

In addition, diaphragms 404 deform at the same point irrespective of where the pressure is applied to the elastic membrane. This is due to the centralized channels 409, which ensure that the diaphragms deform at a centralized point. In this way, different measured values being calculated for applied pressures of substantially similar magnitude can therefore be avoided.

In alternative embodiments, a plurality of channels is provided which are centrally symmetrically distributed along the center axis of force sensing device 401. Thus, when a pressure is applied to any point on the elastic membrane. Again, due to the flow of the force transmission fluid, a pressure value received at each point on the deformable diaphragm is equal and equal to the applied force.

In addition, the deformable diaphragm in this embodiment deforms at multiple points corresponding to a respective channel, however the position where the deformable diaphragm deforms remains unchanged, which again avoids different measured values being calculated by the application of a force at alternative points on the elastic membrane.

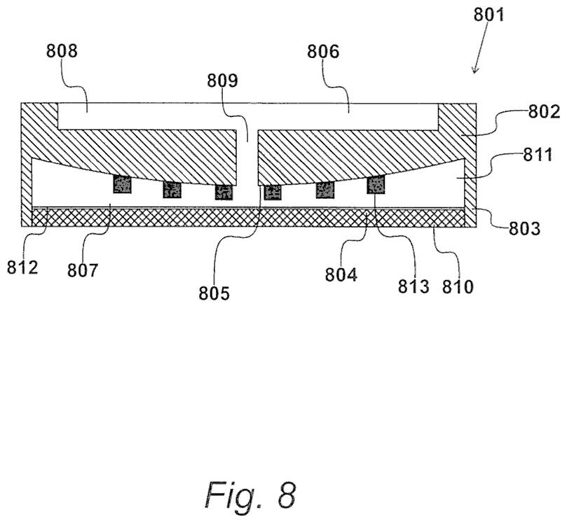

### FIG. 8

A cross-sectional view of a third embodiment of a pressure sensing device 801 in accordance with the present invention will now be described with respect to FIG. 8.

In this third embodiment, pressure sensing device 801 may also be considered a thin-film pressure sensor. However, it is appreciated that other pressure sensing devices which operate in a substantially similar manner to the claimed invention are within the scope of protection sought.

Pressure sensing device 801 comprises a housing 802 which includes a first force transmission device 803 defined by housing 802. Pressure sensing device 801 further comprises a first diaphragm 804 and a second diaphragm 805.

In the embodiment, force transmission device 803 is provided with a cavity 806 which comprises an inner cavity 807, an outer cavity 808 and a channel 809. In a similar manner to previous embodiments, channel 809 connects inner cavity 807 to outer cavity 808 and is located substantially centrally along a central longitudinal axis of pressure sensing device 801.

In this embodiment, diaphragm 804 is positioned along a lower wall 810 which is substantially flexible and configured to be deformable in a normal direction to the central longitudinal axis of pressures sensing device 801. Thus, diaphragm 804, in being attached to lower wall 810, deforms along with lower wall 810 in use.

In the embodiment, diaphragm 805 is non-deformable and is attached to an upper wall 811 of inner cavity 807.

In the embodiment, diaphragm 805 are each provided with a pressure sensitive material 812 coated on its upper surface. As described previously, pressure sensitive material 812 comprises a quantum tunnelling material. Diaphragm 805, in contrast, is provided with a detection electrode 813, which may be substantially similar to detection electrode 301.

The upper wall 811 of inner cavity 807 comprises an arc-shaped cross-section which protrudes towards lower wall 810. This ensures that diaphragm 804 and diaphragm 805 are in close proximity in the rest configuration of FIG. 8.

It is appreciated that the remaining features of force sensing device 801 are substantially similar to those described previously, including the inclusion of a force transmission fluid in cavity 806 and an elastic membrane formed across an opening of cavity 806.

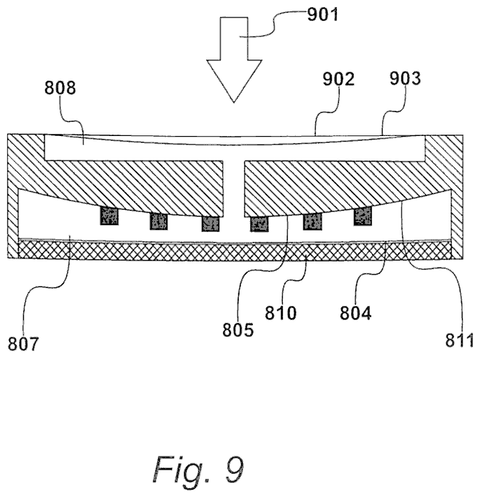

### FIG. 9

A schematic diagram of pressure sensing device 801 under an application of pressure is shown in FIG. 9.

In the embodiment, a force 901 is applied on an upper surface 902 of elastic membrane 903. This application of force may be from a user's finger, in for example, in an embodiment where the pressure sensing device is incorporated into an electronic device which requires pressure inputs from a user.

In the embodiment, when force 901 is applied on upper surface 902, force 901 acts on elastic membrane 903 which causes the force transmission fluid to flow from the outer cavity 808 to the inner cavity 807.

The volume of outer cavity 808 therefore decreases and the volume of the inner cavity 807 consequently increases. Lower wall 810 is deformed under the pressure from force transmission fluid such that lower wall 810 moves away from upper wall 811, and the two diaphragms 804 and 805 move away from each other. During this process, the resistance value changes gradually. Thus, a measurement of the change in resistance can be made.

It is noted that lower wall 810 has an elastic strength which is sufficient to support the weight of the force transmission fluid, such that, in the absence of an applied external force, lower wall 810 does not deform significantly.

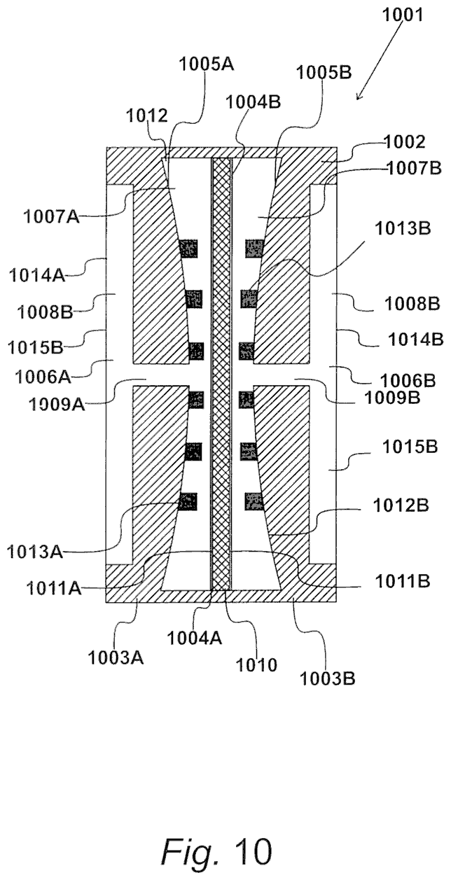

### FIG. 10

A cross-sectional view of a fourth embodiment of pressure sensing device 1001 in accordance with the present invention is shown in FIG. 10.

In this fourth embodiment, pressure sensing device 1001 may again be considered a thin-film pressure sensor. However, it is appreciated that other pressure sensing devices which operate in a substantially similar manner to the claimed invention are within the scope of protection sought.

Pressure sensing device 1001 comprises a housing 1002 which includes a first force transmission device 1003A defined by housing 1002 and a second force transmission device 1003B, also defined by housing 1002. Pressure sensing device 1001 further comprises a first diaphragm 1004A, a second diaphragm 1005A, third diaphragm 1004B and fourth diaphragm 1005B.

In the embodiment, each force transmission device 1003 is provided with a cavity 1006 which comprises an inner cavity 1007, an outer cavity 1008 and a channel 1009. As with previous embodiments, channel 1009 connects inner cavity 1007 to outer cavity 1008 and is located substantially centrally along a central longitudinal axis of pressure sensing device 1001. Each channel 1009 has a central axis therethrough which is perpendicular to the longitudinal axis of pressure sensing device 1001.

The arrangement of each force transmission device is symmetrical along the longitudinal axis of the pressure sensing device 1001, with each force transmission device 1003 being substantially similar to force transmission device 1003.

As shown in FIG. 10, inner cavities 1006A and 1006B share a center wall 1010, which is substantially flexible and is configured to move in the normal direction to the longitudinal axis of force sensing device 1001.

In the embodiment, diaphragms 1004A and 1004B are deformable and attached to corresponding sides of center wall 1010. Diaphragms 1004A and 1004B are each provided with a pressure sensitive material 1011 coated on their upper surface. As described previously, pressure sensitive material 1011 comprises a quantum tunnelling material.

In the embodiment, diaphragms 1005A and 1005B are non-deformable and attached to upper walls 1012 of inner cavities 1007. Each diaphragm 1005 is provided with detection electrode 1013, which, in each case may be substantially similar to detection electrode 301 described previously.

In the embodiment, each cavity 406 comprises a force transmission fluid therein and an elastic membrane 1014 is provided at an opening 1015. Again, each elastic membrane 1014A, 1014B is sealed at its edges to the inner wall of housing 1002.

In this embodiment, the two force transmission devices are arranged back-to-back, however, since lower wall 1010 is substantially flexible, the two cavities 1006A and 1006B in this embodiment can be deformed cooperatively.

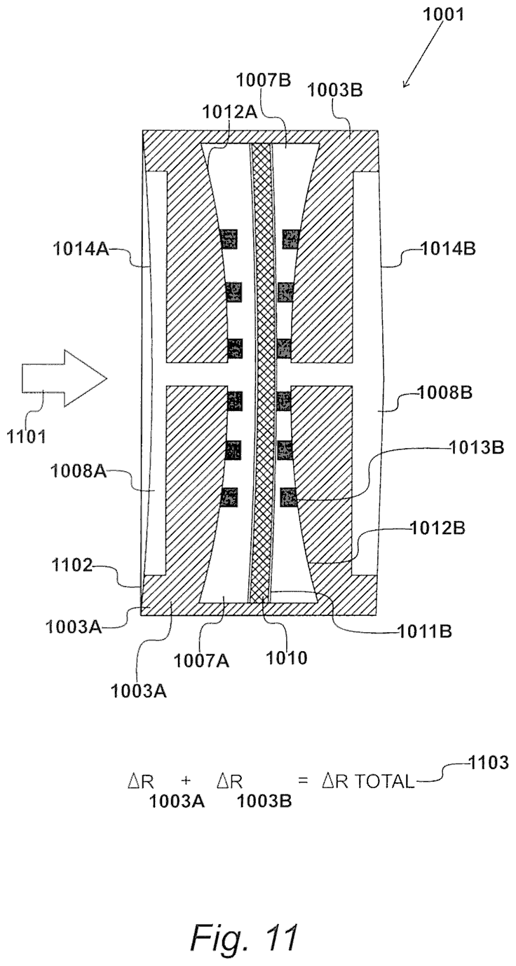

### FIG. 11

A schematic diagram of pressure sensing device 1001 is shown in FIG. 11 under an application of pressure. In this embodiment, pressure 1101 is applied to a side 1102 of pressure sensing device 1001.

On application of pressure 1101, pressure 1101 acts on elastic membrane 1014A which deforms in the direction in which the pressure is applied. The force transmission fluid in cavity 1006A therefore flows from outer cavity 1008A to inner cavity 1007A. Thus, the volume of outer cavity 1008A decreases while the volume of inner cavity 1007A increases, such that center wall 1010 deforms in a convex manner in the direction of the force applied. Thus, wall 1010 moves away from wall 1012A such that the resistance value measured in force transmission device 1003A changes gradually.

Additionally, wall 1010 compresses the force transmission fluid in cavity 1007B such that the force transmission fluid flows from inner cavity 1007B to outer cavity 1008B. Thus, the volume of outer cavity 1008B increases, and elastic membrane 1014B deforms in the direction of applied force. During this process, center wall 1010 and wall 1012B are brought into close contact, such that pressure sensitive material 1011B and detection electrode 1013B are in contact. In this way, a resistance value measured in force transmission device 10038 changes gradually.

Thus, the change in resistance can be measured. As depicted by equation 1103, if the change in resistance measured in force transmission device 1003A is ΔR_{1003A} and the change in resistance measured in force transmission device 1003B is ΔR_{1003B}, then force sensing device 1001 measures a total resistance change of ΔR_{1003A}+ΔR_{1003B}.

For a given applied pressure therefore, pressure sensing device 1001 obtains twice the measured value upon application of a single force on one side of the force sensing device. This enables the detection sensitivity to be improved, particularly in the case of low applied pressures.

It is appreciated that a substantially similar output is achieved if the external force or pressure is applied on the opposite side of force sensing device 1001.

The present invention provides a force or pressure sensing device which includes a force transmission fluid. The main principle of the pressure sensing device is that it utilizes the fluid's absorption and dispersion of pressure to achieve the effect of uniform transmission of external pressure. This ensures that the problems experienced with uneven pressure conduction and inaccurate measurement values by pressure application at different points are reduced.

1. A pressure sensing device, comprising:
a first diaphragm which is deformable; and
a second diaphragm which is non-deformable, wherein:
one of said first diaphragm or said second diaphragms comprises a pressure sensitive material arranged on a surface of said one of said first diaphragm or said second diaphragm,
the other of said first diaphragm or said second diaphragms comprises a detection electrode arranged on a surface of said other said first diaphragm or said second diaphragm,
said first diaphragm forms part of a force transmission device comprising a cavity having a force transmission fluid therein, and
said force transmission device is configured to receive an external force and transmit said external force to said first diaphragm, such that said first diaphragm and said second diaphragms are mutually deformed in response to said external force.

2. The pressure sensing device of claim 1, wherein said cavity is defined by a housing and comprises an inner cavity and an outer cavity connected by a channel.

3. The pressure sensing device of claim 2, wherein said second diaphragm is attached to a lower wall of said inner cavity.

4. The pressure sensing device of claim 3, wherein said lower wall is substantially rigid.

5. The pressure sensing device of claim 2, wherein said first diaphragm is attached to a lower wall of said inner cavity.

6. The pressure sensing device of claim 5, wherein said lower wall is substantially flexible.

7. The pressure sensing device of claim 2, wherein said first diaphragm is suspended in said inner cavity.

8. The pressure sensing device of claim 7, wherein said first diaphragm is hermetically sealed to a side wall of said cavity.

9. The pressure sensing device of claim 2, wherein said second diaphragm is attached to an upper wall of said inner cavity, said upper wall having an arc-shaped cross-section which protrudes towards a lower wall of said inner cavity.

10. The pressure sensing device of claim 1, further comprising an elastic membrane provided at an opening to said cavity, wherein said elastic membrane is sealed to an inner wall of said cavity.

11. The pressure sensing device of claim 1, wherein said force transmission fluid is any one of the following:
silicone oil; glycerin; a non-conductive liquid.

12. The pressure sensing device of claim 1, wherein:
said detection electrode comprises a first plurality of conductive fingers arranged at intervals, and a second plurality of conductive fingers arranged at alternative intervals to produce an arrangement of interdigitated fingers, and
said first plurality of conductive fingers are connected to a positive electrode and said second plurality of conductive fingers are connected to a negative electrode.

13. The pressure sensing device of claim 12, wherein said arrangement of interdigitated fingers provides a detection area, said detection area being any one of the following:
substantially circular; substantially rectangular; a geometric shape.

14. The pressure sensing device of claim 12, wherein each said first plurality of conductive fingers and each said second plurality of conductive fingers comprises a carbon-based material.

15. The pressure sensing device of claim 2, wherein said channel has a center axis therethrough which is perpendicular to a longitudinal axis of said pressure sensing device.

16. The pressure sensing device of claim 15, wherein said channel is located along a center axis of said pressure sensing device.

17. The pressure sensing device of claim 16, further comprising a plurality of channels, each said channel of said plurality of channels being centrally symmetrically distributed along said center axis of said pressure sensing device.

18. The pressure sensing device of claim 1, wherein said pressure sensitive material comprises a quantum tunnelling material.
